(19) United States
(12) Patent Application Publication
(10) Pub. No.: US 2007/0037049 A1
(43) Pub. Date: Feb. 15, 2007

(54) Auxiliary power unit

(75) Inventors: Tsuyoshi Iijima, Tokyo (JP); Kazuya Ogawa, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/500,449

(22) Filed: Aug. 8, 2006

(30) Foreign Application Priority Data
Aug. 11, 2005 (JP) P2005-233430

(51) Int. Cl. H01M 2/10

(52) U.S. Cl. 429/99

(57) ABSTRACT

An auxiliary power unit of the present invention has an auxiliary lithium-ion secondary battery, a charge connector connected to the auxiliary lithium-ion secondary battery and adapted to receive power from an external charger, and a supply connector connected to the auxiliary lithium-ion secondary battery and adapted to supply power of the auxiliary lithium-ion secondary battery to an external portable device, and the auxiliary lithium-ion secondary battery is constructed so that each of thicknesses of cathode active material and anode active material layers is in the range of 10 to 40 μm.

### BACKGROUND OF THE INVENTION

1. Field of the Invention

The present invention relates to an auxiliary power unit.

2. Related Background Art

With recent functional sophistication of lithium-ion secondary batteries, there are expanding demands for a variety of portable equipment such as cell phones, PDAs, and notebook PCs driven by the lithium-ion secondary batteries. For charging the main lithium-ion secondary battery of such portable equipment, it is usually necessary to connect the portable equipment to a charger dedicated to the main lithium-ion secondary battery of each portable equipment and to activate this charger by AC source. However, it is usually difficult to effect such charge at places where one is away from home or office. There are thus desires for an auxiliary power unit capable of readily supplying power to the portable equipment at places where one is away from home or office.

A known auxiliary power unit, for example, as disclosed in Japanese Patent Application Laid-Open No. 2004-111227, is provided with an auxiliary lithium secondary battery, a charge connector for charging this auxiliary lithium secondary battery, and a supply connector for supplying the power of the auxiliary lithium secondary battery to the portable equipment. The auxiliary power unit of this configuration is able to supply the power from the auxiliary lithium-ion secondary battery of the auxiliary power unit to the portable equipment and to be repeatedly used by charging the auxiliary lithium-ion secondary battery itself of the auxiliary power unit with an external charger.

### SUMMARY OF THE INVENTION

However, the auxiliary power unit is required to be more downsized than the portable equipment and the rated capacity Cs of the auxiliary lithium-ion secondary battery of the auxiliary power unit is thus considered to be smaller than the rated capacity Cm of the main lithium-ion secondary battery built in the portable equipment.

If the auxiliary lithium-ion secondary battery of the auxiliary power unit as described above is attempted to be charged by the charger for the main lithium-ion secondary battery, there will arise the following problem. Namely, this charger is optimized for charge of the main lithium-ion secondary battery with the larger rated capacity, and is designed, for example, so that an electric current of at most 1 Cm can flow, based on the rated capacity Cm of the main lithium-ion secondary battery. If this charger is used to charge the auxiliary lithium-ion secondary battery with the rated capacity smaller than the rated capacity Cm, a large electric current inappropriate for the auxiliary lithium-ion secondary battery will flow in the auxiliary lithium-ion secondary battery.

In the above-described auxiliary power unit, therefore, metal lithium becomes likely to separate out on the negative electrode during the charge and repeated use of the unit will lead to considerable degradation of the capacity of the auxiliary power unit and also cause a safety problem.

The present invention has been accomplished in view of the above problem and an object of the invention is to provide a safer auxiliary power unit capable of adequately suppressing the degradation of capacity even if charged with the use of the charger dedicated to portable equipment, while achieving sufficient downsizing.

The Inventors conducted elaborate research and found that when the thicknesses of anode active material and cathode active material layers in the lithium-ion secondary battery of the auxiliary power unit were made thinner than before, i.e., in the range of 10 to 40 μm, the degradation of capacity could be adequately suppressed even through repeated charging steps with a large current, thus accomplishing the present invention.

An auxiliary power unit according to the present invention comprises an auxiliary lithium-ion secondary battery; a charge connector connected to the auxiliary lithium-ion secondary battery and adapted to receive power from an external charger; and a supply connector connected to the auxiliary lithium-ion secondary battery and adapted to supply power of the auxiliary lithium-ion secondary battery to external portable equipment. The auxiliary lithium-ion secondary battery comprises a cathode active material layer, an anode active material layer, and an electrolytic solution, and each of thicknesses of the cathode active material layer and the anode active material layer is in the range of 10 to 40 μm.

Preferably, the portable equipment is one having a main lithium-ion secondary battery, the charger is one for the main lithium-ion secondary battery, and a rated capacity of the auxiliary lithium-ion secondary battery is not more than one third of a rated capacity of the main lithium-ion secondary battery. In this case, the degradation of capacity with passage through charge and discharge cycles can be extremely adequately suppressed, particularly, even if the auxiliary lithium-ion secondary battery of the auxiliary power unit is charged with the use of the charger for the main lithium-ion secondary battery.

Preferably, the auxiliary power unit further comprises a housing of a box shape housing the auxiliary lithium-ion secondary battery, the charge connector and the supply connector are located on side faces of the housing, and the charge connector and the supply connector are located opposite to each other with the housing in between.

This configuration adequately realizes the thin and compact auxiliary power unit.

The present invention successfully realizes the safer auxiliary power unit capable of adequately suppressing the degradation of capacity even if charged with the use of the charger dedicated to portable equipment, while achieving sufficient downsizing.

### BRIEF DESCRIPTION OF THE DRAWINGS

FIG. 1 is a schematic perspective view showing a power supply system for portable equipment according to an embodiment.

FIG. 2 is a circuit diagram of an auxiliary power unit shown in FIG. 1.

FIG. 3 is a partly broken perspective view of an auxiliary lithium-ion secondary battery shown in FIG. 1.

FIG. 4 is a sectional view along XZ plane of the auxiliary lithium-ion secondary battery shown in FIG. 3.

FIG. 5 is a table indicating conditions and results in Examples 1 to 3 and Comparative Examples 1 and 2.

### DESCRIPTION OF THE PREFERRED EMBODIMENTS

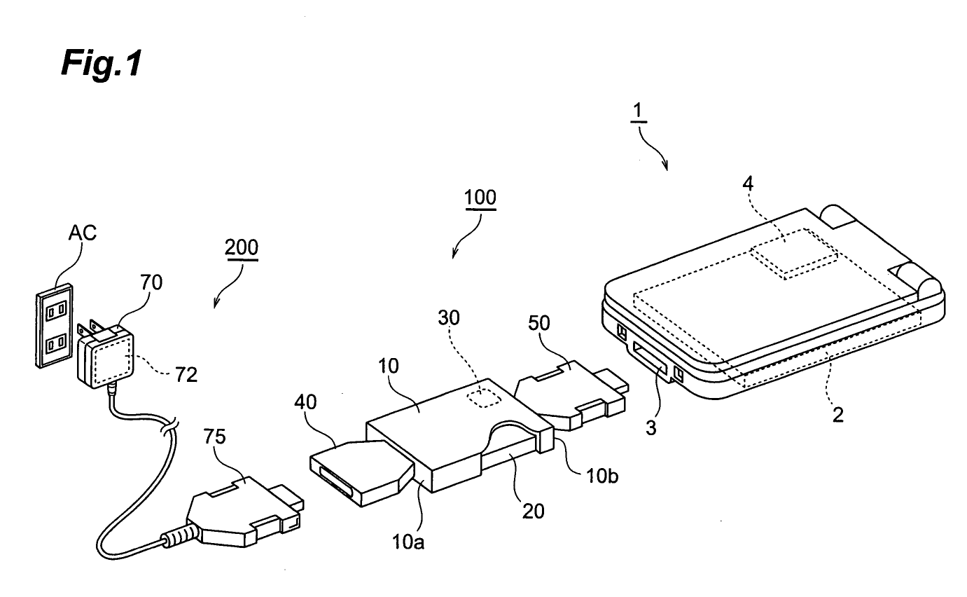

First, a power supply system for portable equipment using an auxiliary power unit of the present invention will be described with reference to FIG. 1.

The present system comprises a cell phone (portable equipment) 1 having a main lithium-ion secondary battery 2, an auxiliary power unit 100 for supplying an auxiliary power to the cell phone 1, and a charger 200 designed to be able to suitably charge the main lithium-ion secondary battery 2 of the cell phone 1.

The cell phone 1 comprises the main lithium-ion secondary battery 2 for activating the cell phone 1, and a connector 3 for charging the main lithium-ion secondary battery 2. This cell phone 1 is equipped with a control computer 4 necessary for fulfilling a function of the cell phone and is also provided with a display, a keyboard, a microphone, a speaker, a charge control circuit, etc., which are not illustrated.

There are no particular restrictions on the main lithium-ion secondary battery 2, and any well-known lithium-ion secondary battery can be adopted.

The charger 200 comprises a plug 70 for connection to an AC outlet AC, a charge control circuit 72 for converting an AC voltage to a DC voltage and for controlling an electric current and voltage so as to suitably charge the main lithium-ion secondary battery 2 of cell phone 1, and a connector 75 connectable to the connector 3 of cell phone 1.

The charge control circuit 72 is one implementing so-called constant-current and constant-voltage charge and performs the following control: before the voltage reaches 4.2 V, the electric current flowing to the main lithium-ion secondary battery 2 is controlled to 1 Cm[A], based on the rated capacity Cm[Ah] of the main lithium-ion secondary battery; after the voltage reaches 4.2 V, the voltage is controlled to be constant at 4.2 V. This permits the main lithium-ion secondary battery 2 to be charged within a short period of time and without degradation of capacity. For example, in the case of a battery having the rated capacity C of 1350 mAh, the electric current of 1 C is equivalent to 1.35 A.

As described above, the charger 200 is one optimized for charge of the main lithium-ion secondary battery 2 of cell phone 1.

The connector 75 is connectable to the connector 3 of cell phone 1, and this enables charge of the main lithium-ion secondary battery 2.

The auxiliary power unit 100 of the present embodiment has the following principal components: housing 10, charge connector 40, supply connector 50, auxiliary lithium-ion secondary battery 20, and charge-discharge control circuit 30.

The charge connector 40 is connectable to the connector 75 of the charger 200. The supply connector 50 is connectable to the connector 3 of cell phone 1.

The housing 10 is made of plastic or metal, and internally houses the auxiliary lithium-ion secondary battery 20 and the charge-discharge control circuit 30. The housing 10 is of a hollow box shape, the charge connector 40 is disposed on a side face 10a of the housing 10, and the supply connector 50 is disposed on a side face 10b of the housing 10. Namely, the charge connector 40 and the supply connector 50 are located opposite to each other with the housing 10 in between. This can realize the thin and compact auxiliary power unit 100.

There are no particular restrictions on the shapes and others of the connectors 40, 50, and the connectors 40, 50 can be modified according to the connector 3 of cell phone 1 and the connector 75 of the charger.

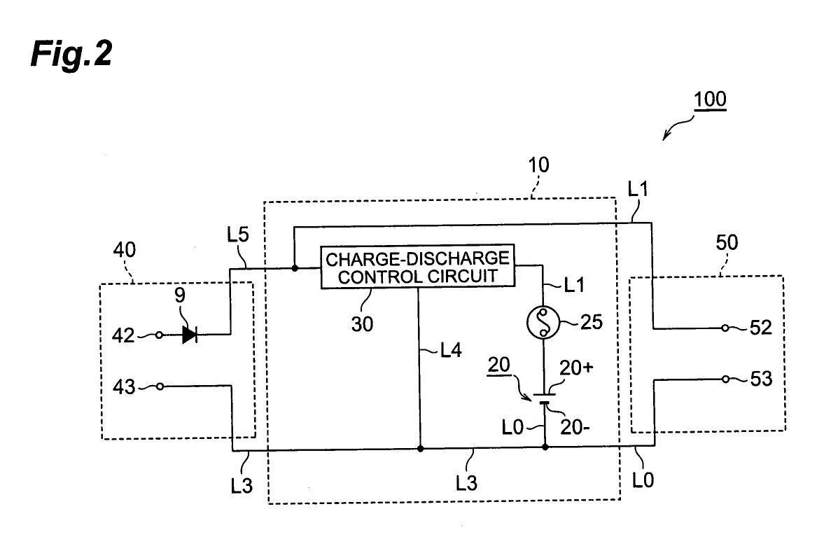

Subsequently, a circuit diagram of the auxiliary power unit 100 will be described with reference to FIG. 2.

The supply connector 50 has terminal 52 and terminal 53. The charge connector 40 has terminal 42 and terminal 43.

The negative electrode 20− of the auxiliary lithium-ion secondary battery 20 and the terminal 53 are electrically connected through line L0. Furthermore, the negative electrode 20− and the terminal 43 are electrically connected through line L0 and line L3 branched from the line L0.

On the other hand, the positive electrode 20+ of the auxiliary lithium-ion secondary battery 20 and the terminal 52 are electrically connected through line L1. A thermal fuse 25 and charge-discharge control circuit 30 are connected in series on the line L1. A line L4 branched from the line L3 is also connected to the charge-discharge control circuit 30. The positive electrode 20+ and the terminal 42 are electrically connected through the line L1 and line L5 branched from the line L1, and the positive electrode 20+ and the terminal 42 are electrically connected through the charge-discharge control circuit 30 and thermal fuse 25. A diode 9 is further connected on the line L5 in order to flow an electric current only from the terminal 42 to the positive electrode 20+.

The charge-discharge control circuit 30 is a control circuit configured as follows: in order to prevent over discharge from the auxiliary lithium-ion secondary battery 20, it breaks the circuit to interrupt discharge when the voltage of the auxiliary lithium-ion secondary battery 20 becomes lower than a predetermined threshold; in order to prevent over charge into the auxiliary lithium-ion secondary battery 20, it breaks the circuit to interrupt charge when the voltage of the auxiliary lithium-ion secondary battery 20 exceeds a predetermined maximum threshold.

The thermal fuse 25 breaks the line L1 when the temperature reaches a predetermined high temperature, e.g., 90° C.

Subsequently, an embodiment of the auxiliary lithium-ion secondary battery 20 will be described in detail.

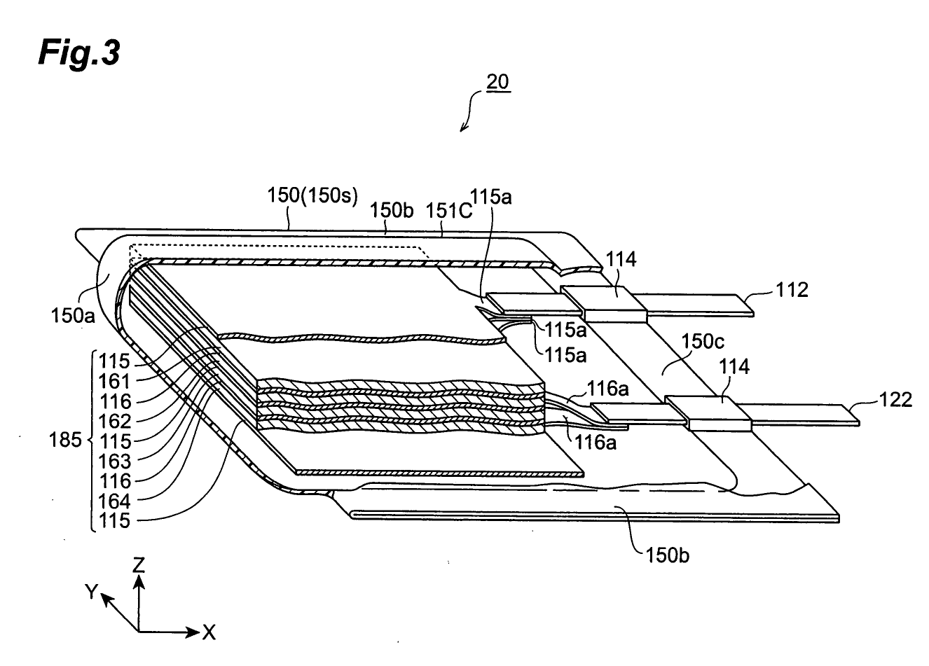

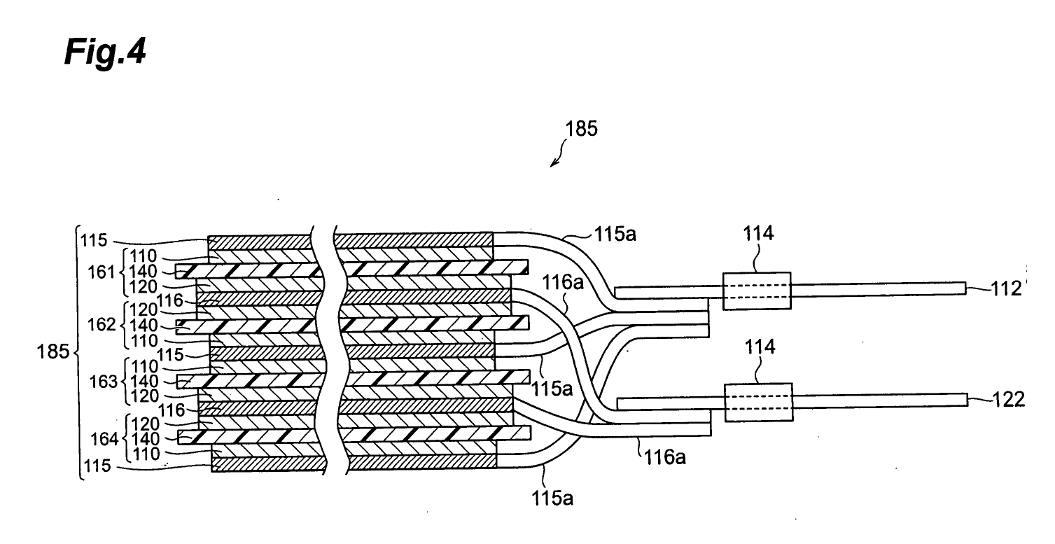

FIG. 3 is a partly broken perspective view of the auxiliary lithium-ion secondary battery 20. FIG. 4 is a sectional view along ZX plane of laminated structure 185, lead 112, and lead 122 shown in FIG. 3.

The auxiliary lithium-ion secondary battery 20 of the present embodiment, as shown in FIGS. 3 and 4, is composed mainly of a laminated structure 185, a case (envelope) 150 housing the laminated structure 185 in a hermetically closed state, and a lead 112 and a lead 122 for connecting the laminated structure 185 to the outside of the case 150. The laminated structure 185 has the following components in order from top: cathode collector 115, secondary cell element 161, anode collector 116, secondary cell element 162, cathode collector 115, secondary cell element 163, anode collector 116, secondary cell element 164, and cathode collector 115, each of which has a plate shape.

(Secondary Cell Elements)

Each of the secondary cell elements 161, 162, 163, and 164, as shown in FIG. 4, is composed of a sheet-like cathode active material layer 110 and a sheet-like anode active material layer 120 facing each other, a sheet-like, electrically insulating separator 140 adjacently disposed between the cathode active material layer 110 and the anode active material layer 120, and an electrolytic solution (not shown) containing an electrolyte and included in the cathode active material layer 110, anode active material layer 120, and separator 140.

The anode active material layer 120 of each secondary cell element 161-164 is formed on a surface of the anode collector 116 and the cathode active material layer 110 of each secondary cell element 161-164 is formed on a surface of the cathode collector 115.

(Anode Active Material Layers)

The anode active material layers 120 are layers containing an anode active material, a conductivity aid, a binder, and so on. The anode active material layers 120 will be described below.

There are no particular restrictions on the anode active material as long as it can reversibly effect occlusion and release of lithium ions, description and insertion of lithium ions, or doping and dedoping of lithium ions and counter anions (e.g., ClO₄⁻) to the lithium ions. The anode active material can be one of the materials as used in the well-known lithium-ion secondary cell elements. For example, the anode active material can be selected from carbon materials such as natural graphite, artificial graphite, mesocarbon microbeads, mesocarbon fiber (MCF), cokes, glassy carbon, and sintered bodies of organic compounds, metals such as Al, Si, and Sn capable of reacting with lithium, amorphous compounds consisting primarily of an oxide such as SiO₂ or SnO₂, lithium titanate (Li₄Ti₅O₁₂), and so on.

In the present embodiment, particularly, the thickness of each anode active material layer 120 needs to be in the range of 10 to 40 μm. An amount of the anode active material supported in the anode active material layers 120 is preferably in the range of 2.0 to 5.0 mg/cm². The supported amount herein is a weight of the anode active material per unit area of the surface of anode collector 116.

There are no particular restrictions on the conductivity aid as long as it can improve the electric conductivity of the anode active material layers 120. The conductivity aid can be one of the well-known conductivity aids. For example, it can be selected from carbon blacks, carbon materials, metal fine powders of copper, nickel, stainless steel, iron, and so on, mixtures of the carbon materials and metal fine powders, and conductive oxides such as ITO.

There are no particular restrictions on the binder as long as it can bind particles of the anode active material and particles of the conductivity aid to the anode collectors 116. The binder can be one of the well-known binders. For example, it can be selected from fluoro resins such as polyvinylidene fluoride (PVDF), polytetrafluoroethylene (PTFE), a tetrafluoroethylene-hexafluoropropylene copolymer (FEP), a tetrafluoroethylene-perfluoro alkyl vinyl ether copolymer (PEA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF), styrene-butadiene rubber (SBR), and so on.

There are no particular restrictions on a material for the anode collectors 116 to be bound to the anode active material layers 120, as long as it is a metal material usually used as a collector for the anode active material layers of the lithium-ion secondary batteries. For example, the material can be copper, nickel, or the like. A tongue 116a as an outward extension of each collector is formed at an end of each anode collector 116, as shown in FIGS. 3 and 4.

(Cathode Active Material Layers)

The cathode active material layers 110 are layers containing a cathode active material, a conductivity aid, a binder, and so on. The cathode active material layers 110 will be described below.

There are no particular restrictions on the cathode active material as long as it can reversely effect occlusion and release of lithium ions, description and insertion (intercalation) of lithium ions, or doping and dedoping of lithium ions and counter anions (e.g., ClO₄⁻) to the lithium ions. It can be one of the well-known electrode active materials. For example, it can be selected from complex metal oxides such as lithium cobaltite (LiCoO₂), lithium nickelite (LiNiO₂), lithium manganese spinel (LiMn₂O₄), and those represented by general formula: LiNiₓCo_{y}Mn_{z}O₂(x+y+z=1), and complex metal oxides such as lithium vanadium compounds (LiV₂0₅), olivine LiMPO₄ (where M represents Co, Ni, Mn, or Fe), and lithium titanate (L₄Ti₅O₁₂).

In the present embodiment, particularly, the thickness of each cathode active material layer 110 needs to be in the range of 10 to 40 μm. An amount of the cathode active material supported in the cathode active material layers 110 can be optionally and appropriately determined according to the supported amount of the anode active material in the anode active material layers 120, but is preferably, for example, in the range of 3.0 to 10.0 mg/cm².

The components other than the cathode active material contained in the cathode active material layers 110 can be the same materials as those constituting the anode active material layers 120. The cathode active material layers 110 also preferably contain the same conductivity aid as that in the anode active material layers 120.

There are no particular restrictions on a material for the cathode collectors 115 to be bound to the cathode active material layers 110, as long as it is a metal material usually used as a collector for the cathode active material layers of the lithium-ion secondary batteries. For example, it is aluminum or the like. A tongue 115a as an outward extension of each collector is formed at an end of each cathode collector 115, as shown in FIGS. 3 and 4.

(Separators)

The separators 140 interposed between the anode active material layers 120 and the cathode active material layers 110 are made of an electrically insulating porous material. There are no particular restrictions on the material for the separators 140, and it can be one of the well-known separator materials. For example, the electrically insulating porous material can be selected from laminates of films consisting of polyethylene, polypropylene, or polyolefm, oriented films of mixtures of the foregoing resins, or nonwoven fabric of fiber consisting of at least one component selected from the group consisting of cellulose, polyester, and polypropylene.

In each of the secondary cell elements 161-164, as shown in FIG. 4, the constituent layers decrease their area in the order of separator 140, anode active material layer 120, and cathode active material layer 110, the end faces of the anode active material layer 120 project outward with respect to the end faces of the cathode active material layer 110, and the end faces of the separator 140 project outward with respect to the end faces of the anode active material layer 120 and cathode active material layer 110.

This makes it easier to oppose the entire surface of the cathode active material layer 110 to the anode active material layer 120 in each secondary cell element 161-164 even if each layer has some positional deviation in a direction intersecting with the stack direction because of error or the like during production. Therefore, lithium ions released from the cathode active material layer 110 can be adequately taken through the separator 140 into the anode active material layer 120. If lithium ions were not adequately taken into the anode active material layer 120, lithium ions not taken into the anode active material layer 120 would separate out to decrease carriers of electric energy, so as to degrade the energy capacity of the battery. Furthermore, since the separator 140 is larger than the cathode active material layer 110 and the anode active material layer 120 and projects from the end faces of the cathode active material layer 110 and anode active material layer 120, it reduces chances of a short circuit due to contact between the cathode active material layer 110 and the anode active material layer 120.

(Electrolytic Solution)

The electrolytic solution is contained in the anode active material layers 120 and the cathode active material layers 110, and inside pores of the separators 140. There are no particular restrictions on the electrolytic solution, and it can be an electrolytic solution containing a lithium salt (an aqueous electrolyte solution or an electrolytic solution using an organic solvent) which is used in the well-known lithium-ion secondary cell elements. However, the aqueous electrolyte solution has an electrochemically low decomposition voltage and a withstand voltage thereof during charge is limited to a low value. Therefore, it is preferable to use an electrolytic solution using an organic solvent (i.e., nonaqueous electrolytic solution). A preferably applicable electrolytic solution for the secondary cell elements is one in which a lithium salt is dissolved in a nonaqueous solvent (organic solvent). The lithium salt can be, for example, one selected from salts such as LiPF₆, LiClO₄, LiBF₄, LiAsF₆, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂)(C₄F₉SO₂), and LiN(CF₃CF₂CO)₂. One of these salts may be used alone, or two or more of them may be used in combination.

The organic solvent can be one of the solvents used in the well-known secondary cell elements. Preferred examples of the organic solvent include propylene carbonate, ethylene carbonate, diethyl carbonate, and so on. One of these may be used alone, or two or more of them may be used as mixed at an arbitrary ratio.

In the present embodiment the electrolytic solution may be a gelatinous electrolyte obtained by adding a gelatinizing agent, as well as the liquid electrolytes. Instead of the electrolytic solution, a solid electrolyte (a solid polymer electrolyte or an electrolyte consisting of an ion conductive inorganic material) may be contained.

(Leads)

The lead 112 and the lead 122, as shown in FIG. 3, have a ribbon-like contour and project from the interior of the case 150 through seal portions 150c to the outside.

The leads 112 are made of a conductive material such as metal. This conductive material can be, for example, aluminum or the like. The end of the lead 112 inside the case 150 is bonded to the tongues 115a, 115a, 115a of the respective cathode collectors 115, 115, 115 by resistance welding or the like, as shown in FIG. 3, and the lead 112 is electrically connected through each cathode collector 115 to each cathode active material layer 110.

On the other hand, the lead 122 is also made of a conductive material such as metal. This conductive material can be, for example, an electrically conductive material such as copper or nickel. The end of the lead 122 inside the case 150 is welded to the tongues 116a, 116a of the anode collectors 116, 116 and the lead 122 is electrically connected through each anode collector 116 to each anode active material layer 120.

The pinched portions of the leads 112, 122 between seal portions 150c of the case 150 are covered by an insulator 114 such as resin, in order to enhance seal performance, as shown in FIGS. 3 and 4. There are no particular restrictions on the material of insulator 114, but it is preferably made, for example, of synthetic resin. The lead 112 and the lead 122 are spaced from each other in a direction perpendicular to the stack direction of the laminated structure 185.

In the present embodiment the lead 112 and the lead 122 correspond to the positive electrode 20+ and to the negative electrode 20−, respectively.

(Case)

There are no particular restrictions on the case 150 as long as it can hermetically seal the laminated structure 185 and prevent air or water from entering the interior of the case. The case can be one of the cases used for the well-known secondary cell elements. For example, the case can be one of synthetic resins such as epoxy resin, or resin laminates of metal sheets such as aluminum. The case 150, as shown in FIG. 3, is one formed by folding a flexible sheet 151C of rectangular shape into two near the longitudinal center part, and thus pinches the laminated structure 185 from both sides in the stack direction (vertical direction). Among the ends of the twofold sheet 151C, the three-edge seal portions 150b, 150b, and 150c except for the folded part 150a are bonded by heat seal or with an adhesive, so as to hermetically seal the laminated structure 185 inside. The case 150 is bonded to the insulators 114 in the seal portions 150c to seal the leads 112, 122.

The auxiliary power unit 100 and the auxiliary lithium-ion secondary battery 20 as described above are required to be adequately smaller than the cell phone 1. Therefore, the rated capacity Cs of the auxiliary lithium-ion secondary battery 20 is preferably smaller than the rated capacity Cm of the main lithium-ion secondary battery 2 of cell phone 1 and particularly preferably not more than one third of the rated capacity Cm of the main lithium-ion secondary battery 2.

Subsequently, a method of use of the auxiliary power unit 100 will be described with reference to FIG. 1.

Preliminarily, the plug 70 is connected to the AC outlet AC and the connector 75 of charger 200 is connected to the charge connector 40 of the auxiliary power unit 100, thereby charging the auxiliary lithium-ion secondary battery 20. After completion of the charge, the connector 75 is disconnected from the charge connector 40 and the auxiliary power unit 100 is carried with the cell phone 1.

When the capacity of the main lithium-ion secondary battery 2 of cell phone 1 becomes reduced with use of cell phone 1, the supply connector 50 of the auxiliary power unit 100 is connected to the connector 3 of cell phone 1. This enables the cell phone 1 to be activated for a longer time by the power from the auxiliary lithium-ion secondary battery 20 of the auxiliary power unit 100 than in the case of only the main lithium-ion secondary battery 2.

After use of the auxiliary power unit 100, the auxiliary power unit 100 is disconnected from the cell phone 1 and the charge connector 40 is again connected to the connector 75 of charger 200 to charge the auxiliary lithium-ion secondary battery 20 of the auxiliary power unit 100. It is also possible to simultaneously charge the main lithium-ion secondary battery 2 and the auxiliary lithium-ion secondary battery 20 by connecting the connector 75 of the charger 200 to the charge connector 40 of the auxiliary power unit 100 and connecting the supply connector 50 of the auxiliary power unit 100 to the connector 3 of the cell phone 1.

In the auxiliary power unit 100 of the present embodiment, the auxiliary lithium-ion secondary battery 20 is constructed so that each of the thicknesses of the cathode active material layers 110 and the anode active material layers 120 is in the range of 10 to 40 μm, the capacity degradation of the auxiliary lithium-ion secondary battery 20 is less likely to occur after passage through charge and discharge cycles even with the use of the charger 200 for charge of the main lithium-ion secondary battery 2.

Specifically, the charge control circuit 72 in the charger 200 for main lithium-ion secondary battery 2 is often designed to implement the charge by an electric current value according to the rated capacity Cm of the main lithium-ion secondary battery 2 as a charging object, e.g., by 1 Cm. However, if the auxiliary lithium-ion secondary battery 20 of the auxiliary power unit 100 is attempted to be charged with this charger 200, since the rated capacity Cs of the auxiliary lithium-ion secondary battery 20 is smaller than the rated capacity Cm of the main lithium-ion secondary battery 2, an extremely larger electric current than 1 Cs on the basis of the rated capacity of the auxiliary lithium-ion secondary battery 20 will flow. In the conventional lithium-ion secondary batteries, the charge with such large current was likely to cause deposition or the like of metal lithium on the electrodes and thus posed the problem of significant degradation of capacity after passage through charge and discharge cycles.

However, since each of the thicknesses of the cathode active material layers 110 and the anode active material layers 120 is set in the range of 10 to 40 μm which is smaller than before, as in the present embodiment, the degradation of capacity is drastically suppressed even if the auxiliary secondary battery is charged with the charger 200 for the main lithium-ion secondary battery 2.

A conceivable reason for achievement of such effect is, for example, as follows. When the thicknesses of the cathode active material layers 110 and the anode active material layers 120 become smaller than before, an area of an interface between each active material layer and the electrolytic solution becomes substantially wider than before. This decreases concentration polarization of Li in the cathode active material layers 110 and in the anode active material layers 120 and thus dendrite deposition of lithium ions is less likely to occur on the anode active material layers 120.

The auxiliary lithium-ion secondary battery 20 can be charged well with the charger configured to supply an electric current equivalent to 9 Cs or more, based on the rated capacity Cs of the auxiliary lithium-ion secondary battery 20.

If each of the thicknesses of the anode active material layers 120 and the cathode active material layers 110 is less than 10 μm, it will lead to increase in the number of laminated layers or the number of turns of the battery and, in turn, to increase of cost of the battery.

(Production Method)

Next, an example of a production method of the above-described auxiliary lithium-ion secondary battery 20 will be described.

The first step is to prepare each of coating solutions (slurries) containing the components for formation of the electrode layers to become the anode active material layers 120 and the cathode active material layers 110. The coating solution for the anode active material layers is a solvent having the aforementioned anode active material, conductivity aid, binder, etc., and the coating solution for the cathode active material layers is a solvent having the aforementioned cathode active material, conductivity aid, binder, and so on. There are no particular restrictions on the solvents used for the coating solutions as long as the binder is soluble therein and the active material and conductivity aid can be dispersed therein. For example, they can be N-methyl-2-pyrrolidone, N,N-dimethyl formamide, or the like.

The next step is to prepare the cathode collectors 115 of aluminum or the like and the anode collectors 116 of copper, nickel, or the like. Then the coating solution for the cathode active material layers is applied onto surfaces of the cathode collectors 115 and dried to form the cathode active material layers 110, as shown in FIG. 4. In addition, the coating solution for the anode active material layers is applied onto surfaces of the anode collectors 116 and dried to form the anode active material layers 120 on the surfaces.

There are no particular restrictions on a technique of applying the coating solutions onto the collectors, and it may be optionally determined according to the materials, shapes, etc. of the metal sheets for the collectors. For example, the applying method can be selected from metal mask printing, electrostatic coating, dip coating, spray coating, roll coating, doctor blade method, gravure coating, screen printing, and so on. After the application, a rolling process by platen press, calender rolls, or the like is performed according to need.

In this step, each of the thicknesses of the cathode active material layers 110 and the anode active material layers 120 is controlled in the range of 10-40 μm. The cathode active material layers 110 and the anode active material layers 120 are formed excluding both sides of the tongues 115a, 116a.

The subsequent step is to prepare the separators 140. The separators 140 are made by cutting an insulating porous material into a rectangular shape larger than the rectangle of the anode active material layer 120 in a 3-layer laminate.

The subsequent step is to stack the cathode collectors 115 with the cathode active material layers 110 thereon and the anode collectors 116 with the anode active material layers 120 thereon so as to sandwich the separators 140 one between each pair in the order of FIG. 4 and thereafter to pinch and heat the in-plane central portions on the two sides in the stack direction to obtain the laminated structure 185 as shown in FIG. 4.

The next step is to prepare the leads 112, 122 as shown in FIG. 3 and to cover the longitudinal centers thereof with respective insulators 114 such as resin. The subsequent step is to weld each tongue 115a to the end of the lead 112 and to weld each tongue 116a to the end of the lead 122, as shown in FIG. 4. This completes the laminated structure 185 to which the lead 112 and the lead 122 are connected.

The next step is to prepare the sheet 150C of rectangular shape made by laminating both surfaces of aluminum with thermo-adhesive resin layers, to fold the sheet at the center of sheet 150s to superinpose one half onto the other, and, as shown in FIG. 3, to heat-seal only the two-side seal portions 150b, 150b on both sides by a desired seal width under predetermined heat conditions, for example, with a sealing machine or the like. The subsequent step is to insert the laminated structure 185 into the interior of the case 150 through the seal portion 150c not sealed yet. The subsequent step is to pour the electrolytic solution into the case 150 inside a vacuum chamber to immerse the laminated structure 185 in the electrolytic solution. Thereafter, a part of each of the leads 112 and 122 is made to project outward from the interior of the case 150, and the seal portion 150c of the case 150 is sealed with a heat sealing machine. At this time, the sealing is performed so that the portions of the leads 112, 122 covered with the insulators 114 are placed between the seal portions 150c. This completes fabrication of the auxiliary lithium-ion secondary battery 20.

The present invention can have a variety of modifications without having to be limited to the above embodiment.

For example, the above embodiment showed the laminated structure 185 having the four secondary cell elements 161-164 as single cells, but the laminated structure may have five or more secondary cell elements, or may have three or less secondary cell elements, e.g., even one secondary cell element.

The portable equipment is not limited to cell phones, but can be, for example, PDAs, notebook PCs, and so on.

### EXAMPLES

The present invention will be described below in further detail with examples and comparative examples, but it is noted that the present invention is by no means intended to be limited to these examples.

Various lithium-ion secondary batteries were fabricated in different thicknesses of the cathode active material layers and the anode active material layers, and auxiliary power units as described above in FIG. 1 were fabricated using these lithium-ion secondary batteries.

### Example 1

First, the cathode active material layers were fabricated according to the following procedure. Materials first prepared were LiMn_{0.33}Ni_{0.33}Co_{0.34}O₂ (the numbers of the subscripts represent an atomic ratio) as the cathode active material, carbon black as the conductivity aid, and polyvinylidene fluoride (PVdF) as a binder, and these were mixed and dispersed at the ratio of these weights of cathode active material:conductivity aid:binder=90:6:4 by a planetary mixer. Thereafter, an appropriate amount of N methyl pyrrolidone (NMP) as a solvent was mixed into the mixture to adjust the viscosity, thereby preparing a slurry coating solution (slurry) for cathode active material layers.

Subsequently, aluminum foil (20 μm thick) was prepared, and the coating solution for cathode active material layers was applied onto the aluminum foil by the doctor blade method and dried to form a cathode active material layer. Next, the applied cathode active material layer was pressed by calender rolls and the resultant was punched into a shape in which the cathode active material layer surface had the size of 23 mm×19 mm and which had the predetermined tongue terminal. The cathode collectors prepared herein were those with the cathode active material layer 110 on only one side, and those with the cathode active material layers on both sides. The thickness of each cathode active material layer 110 was 20 μm.

Subsequently, the anode active material layers were prepared according to the following procedure. Materials first prepared were artificial graphite as the anode active material, carbon black as the conductivity aid, and PVdF as a binder. These were mixed and dispersed at the ratio of these weights of anode active material:conductivity aid:binder=90:2:8 by a planetary mixer, and an appropriate amount of NMP as a solvent was then mixed into the mixture to adjust the viscosity, thereby preparing the slurry coating solution for anode active material layers.

Next, copper foil (thickness: 16 μm) was prepared for collectors, and the coating solution for anode active material layers was applied onto both sides of the copper foil by the doctor blade method and then dried to form anode active material layers. Thereafter, the anode active material layers were pressed by calender rolls and the resultant was punched into a shape in which the anode active material layer surface had the size of 23 mm×19 mm and which had the tongue terminal. The anode collectors prepared herein were those with the anode active material layers on both sides. The thickness of each anode active material layer 120 was 20 μm.

Next, porous films of polyolefin were punched in the size of 24 mm×20 mm to obtain separators.

Subsequently, the collectors and separators were stacked so that the separators were interposed between the anode collectors with the anode active material layers and the cathode collectors with the cathode active material layers, so as to obtain a laminated structure having fourteen layers of secondary cell elements. The central part of the laminated structure was thermally pressed from the both end faces to be fixed. The layers were stacked so that the outermost layers of the laminated structure were the cathode collectors with the cathode active material layer on one side.

Next, a nonaqueous electrolytic solution was prepared as follows. Propylene carbonate (PC), ethylene carbonate (EC), and diethyl carbonate (DEC) were mixed at the volume ratio of 2:1:7 in the order named to obtain a solvent. Next, LiPF₆ was dissolved in the concentration of 1.5 mol/dm³ in the solvent.

Next, a case of laminated aluminum in bag shape was prepared, the laminated structure was inserted thereinto, and the nonaqueous electrolytic solution was poured into the case in a vacuum chamber to impregnate the laminated structure with the nonaqueous electrolytic solution. Thereafter, it was kept in a reduced-pressure state, the entrance of the envelope was sealed so that part of the tongue terminals projected from the envelop, and the initial charge and discharge were conducted to obtain a multilayer lithium-ion secondary battery in the 2043 size (20 mm×43 mm) and with the rated capacity of 100 mAh.

Then the charge and discharge circuit, the charge connector, and the supply connector were connected to the resultant auxiliary lithium-ion secondary battery to obtain an auxiliary power unit. Then this auxiliary power unit was subjected to charge and discharge cycles as repetitions of a charging step of performing constant-current and constant-voltage charging under conditions equivalent to those with the charger for the lithium-ion secondary battery of cell phones with the rated capacity of 600 mAh (maximum voltage 5 V and current 600 mA), and a discharging step of discharging at 100 mA down to the terminal voltage of 2.5 V. The number of cycles was counted when the capacity of the auxiliary lithium secondary battery of the auxiliary power unit became 80% of the initial capacity. The maximum number of cycles was 1000 cycles. The maximum current value during charging was 6 C.

### Example 2

Example 2 was the same as Example 1 except that the auxiliary lithium-ion secondary battery used was the one in which each of the thicknesses of the cathode active material layers and the anode active material layers was 30 μm.

### Example 3

Example 3 was the same as Example 1 except that the auxiliary lithium-ion secondary battery used was the one in which each of the thicknesses of the cathode active material layers and the anode active material layers was 40 μm.

### Comparative Example 1

Comparative Example 1 was the same as Example 1 except that the auxiliary lithium-ion secondary battery used was the one in which each of the thicknesses of the cathode active material layers and the anode active material layers was 50 μm.

### Comparative Example 2

Comparative Example 2 was the same as Example 1 except that the auxiliary lithium-ion secondary battery used was the one in which each of the thicknesses of the cathode active material layers and the anode active material layers was 60 μm.

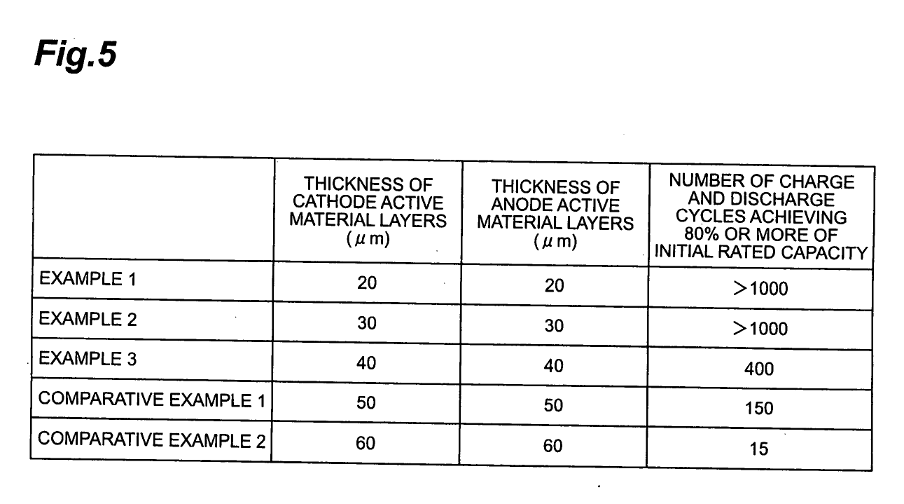

FIG. 5 shows the number of charge and discharge cycles through which the capacity can be maintained at 80% of the initial capacity, for each of these lithium-ion secondary batteries. In Examples 1 to 3, 80% of the initial capacity was maintained before passage of at least 400 cycles, but Comparative Examples 1 and 2 failed to maintain 80% of the initial capacity after 150 or less cycles.

What is claimed is:

1. An auxiliary power unit comprising:
an auxiliary lithium-ion secondary battery;
a charge connector connected to the auxiliary lithium-ion secondary battery and adapted to receive power from an external charger; and
a supply connector connected to the auxiliary lithium-ion secondary battery and adapted to supply power of the auxiliary lithium-ion secondary battery to an external portable device,
wherein the auxiliary lithium-ion secondary battery has a cathode active material layer, an anode active material layer, and an electrolytic solution and wherein each of thicknesses of the cathode active material layer and the anode active material layer is in the range of 10 to 40 μm.

2. The auxiliary power unit according to claim 1, wherein the portable device has a main lithium-ion secondary battery,
wherein the charger is a charger for the main lithium-ion secondary battery, and
wherein a rated capacity of the auxiliary lithium-ion secondary battery is not more than one third of a rated capacity of the main lithium-ion secondary battery.

3. The auxiliary power unit according to claim 1, further comprising a housing of a box shape housing the auxiliary lithium-ion secondary battery,
wherein the charge connector and the supply connector are located on respective side faces of the housing and wherein the charge connector and the supply connector are arranged opposite to each other with the housing in between.

4. The auxiliary power unit according to claim 2, further comprising a housing of a box shape housing the auxiliary lithium-ion secondary battery,
wherein the charge connector and the supply connector are located on respective side faces of the housing and wherein the charge connector and the supply connector are arranged opposite to each other with the housing in between.
